(19) United States
(12) Patent Application Publication
(10) Pub. No.: US 2024/0169550 A1
(43) Pub. Date: May 23, 2024

(54) SPECIFIC POINT DETECTION SYSTEM, SPECIFIC POINT DETECTION METHOD, AND SPECIFIC POINT DETECTION PROGRAM

(71) Applicant: KAWASAKI JUKOGYO KABUSHIKI KAISHA, Kobe-shi, Hyogo (JP)

(72) Inventors: Kentaro AZUMA, Kobe-shi (JP); Kazuki KURASHIMA, Kobe-shi (JP); Hitoshi HASUNUMA, Kobe-shi (JP); Shoichi NISHIO, Kobe-shi (JP)

(73) Assignee: KAWASAKI JUKOGYO KABUSHIKI KAISHA, Kobe-shi, Hyogo (JP)

(21) Appl. No.: 18/552,675

(22) PCT Filed: Mar. 30, 2022
(86) PCT No.: PCT/JP2022/016214

§ 371 Date: Sep. 27, 2023

(30) Foreign Application Priority Data
Mar. 30, 2021 (JP) 2021-058534

(51) Int. Cl. G06T 7/13; G06T 7/174; G06T 7/73

(52) U.S. Cl. CPC G06T 7/13; G06T 7/174; G06T 7/74; G06T 2207/10028; G06T 2207/20081

(57) ABSTRACT

A specific point detection system includes an imager that acquires an image of an object W, a first detector that detects, using a first detection model learned by machine learning, a burr B included in the object W by taking the image acquired by the imager as input, a three-dimensional scanner that acquires three-dimensional information on the object W including the burr B detected by the first detector, and a second detector that re-detects, using a second detection model learned by machine learning, the burr B by taking the three-dimensional information acquired by the three-dimensional scanner as input.

### FIELD

The present disclosure relates to a specific point detection system, a specific point detection method, and a specific point detection program.

### BACKGROUND

Conventionally, a device that detects a specific point included in a workpiece has been known. For example, Patent Document 1 discloses a device that compares a three-dimensional shape expressed using voxels from measurement data on a workpiece and a 3D-CAD model of the workpiece to detect a burr as a specific point.

### CITATION LIST

### Patent Document

Patent Document 1: Japanese Unexamined Patent Application Publication No. 2009-128097

### SUMMARY OF THE INVENTION

In a case where three-dimensional information on an object is measured, i.e., acquired, and a specific point of the object is detected as in Patent Document 1, the finer the three-dimensional information is, the higher the accuracy of detection of the specific point is. In order to acquire the fine three-dimensional information, it is conceivable that three-dimensional information on an enlarged object is acquired and the resolution of the three-dimensional information indicating the object is improved accordingly. However, if the three-dimensional information on the enlarged object is acquired, three-dimensional information only on part of the object can be acquired by single acquisition of the three-dimensional information. For this reason, the number of steps of acquiring the three-dimensional information increases, and the number of steps of detecting the specific point from the three-dimensional information also increases.

The present disclosure has been made in view of the above-described point, and an object thereof is to facilitate processing when a specific point is detected from three-dimensional information on an object.

A specific point detection system of the present disclosure includes an imager that acquires an image of an object, a first detector that detects, using a first detection model learned by machine learning, a specific point included in the object by taking the image acquired by the imager as input, a three-dimensional information acquirer that acquires three-dimensional information on the object including the specific point detected by the first detector, and a second detector that re-detects, using a second detection model learned by machine learning, the specific point by taking the three-dimensional information acquired by the three-dimensional information acquirer as input.

A specific point detection method of the present disclosure includes acquiring an image of an object, detecting, using a first detection model learned by machine learning, a specific point included in the object by taking the image as input, acquiring three-dimensional information on the object including the specific point detected by the first detection model, and re-detecting, using a second detection model learned by machine learning, the specific point by taking the three-dimensional information as input.

A specific point detection program of the present disclosure causes, for detecting a specific point of an object, a computer to execute acquiring an image of the object, detecting, using a first detection model learned by machine learning, the specific point included in the object by taking the image as input, acquiring three-dimensional information on the object including the specific point detected by the first detection model, and re-detecting, using a second detection model learned by machine learning, the specific point by taking the three-dimensional information as input.

According to the specific point detection system, the processing when the specific point is detected from the three-dimensional information on the object can be facilitated.

According to the specific point detection method, the processing when the specific point is detected from the three-dimensional information on the object can be facilitated.

According to the specific point detection program, the processing when the specific point is detected from the three-dimensional information on the object can be facilitated.

### BRIEF DESCRIPTION OF THE DRAWINGS

FIG. 1 is a schematic view showing the configuration of a processing system.

FIG. 2 is a diagram showing a schematic hardware configuration of a robot controller.

FIG. 3 is a diagram showing a schematic hardware configuration of an operation controller.

FIG. 4 is a diagram showing a schematic hardware configuration of a controller.

FIG. 5 is a block diagram showing the configuration of a control system for manual control for the processing system.

FIG. 6 is a block diagram showing the configuration of a control system for automatic control for the processing system.

FIG. 7 is a flowchart of the automatic control for the processing system.

FIG. 8 is a schematic view showing the state of a robot arm in imaging of an object W.

FIG. 9 is a schematic view showing one example of an image acquired by an imager.

FIG. 10 is a schematic view showing the state of the robot arm in acquisition of point cloud data on the object.

FIG. 11 is a schematic view showing one example of point cloud data acquired by a three-dimensional scanner.

FIG. 12 is a schematic view showing the state of the robot arm in grinding of a burr.

### DESCRIPTION OF EMBODIMENTS

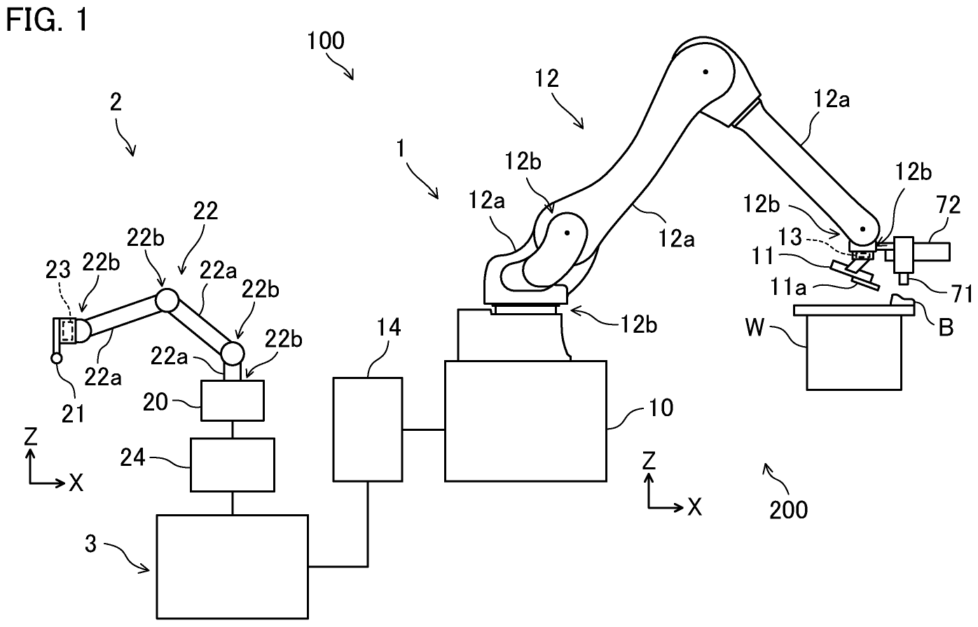

Hereinafter, an exemplary embodiment will be described in detail with reference to the drawings. FIG. 1 is a schematic view showing the configuration of a processing system 100 according to the embodiment. Note that a dashed line in FIG. 1 indicates wireless communication.

The processing system 100 includes a specific point detection system 200 (hereinafter also referred to as a “detection system 200”) that detects a specific point of an object W. In this example, the specific point is a burr of the object W. The burr includes, for example, a casting burr, a cutting burr, a grinding burr, a shear burr, a plastic deformation burr, a gate burr, and a welding burr.

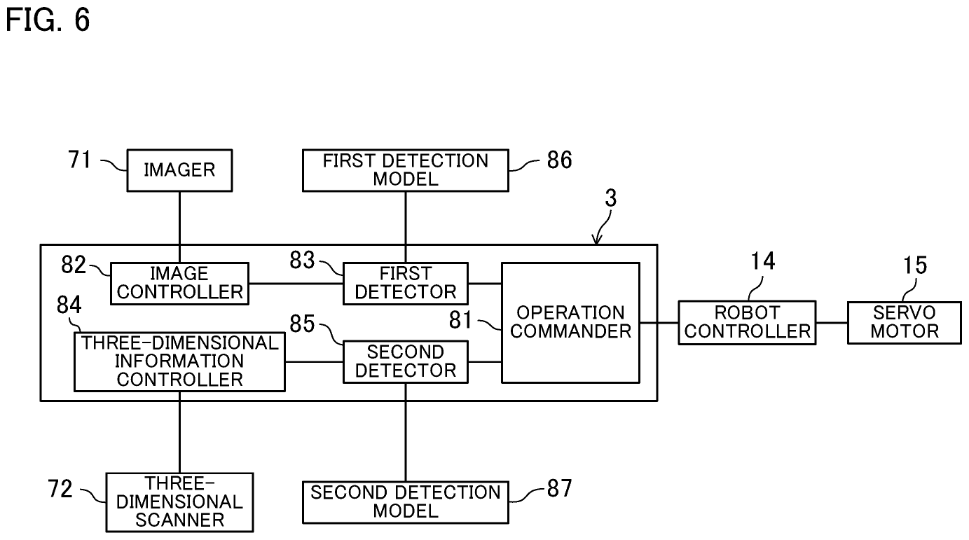

The detection system 200 includes an imager 71 that acquires an image of the object W, a first detector 83 (see FIG. 6) that detects a burr B included in the object W based on the image acquired by the imager 71, a three-dimensional scanner 72 that acquires three-dimensional information on the object W including the burr B detected by the first detector 83, and a second detector 85 (see FIG. 6) that re-detects the burr B based on the three-dimensional information acquired by the three-dimensional scanner 72. The three-dimensional scanner 72 is one example of a three-dimensional information acquirer.

The detection system 200 further includes a robot arm 12. The imager 71 and the three-dimensional scanner 72 are located at the robot arm 12. More specifically, the detection system 200 further includes a robot 1 and a controller 3 that controls the robot 1. The robot arm 12 is included in the robot 1.

The processing system 100 further includes an operator 2 to be operated by a user. The robot 1 acts on the object W according to operation of the operator 2. The controller 3 also controls the operator 2. The robot 1 and the operator 2 are remotely located. The processing system 100 can perform manual processing for the object W and automatic processing for the object W.

The processing system 100 performs remote control between the operator 2 and the robot 1. In the remote control, the operator 2 functions as a master, and the robot 1 functions as a slave.

Note that in the present disclosure, a work performed by the robot 1 does not include a teaching work and a teaching checking/correction work. Thus, the operator 2 does not include a teach pendant.

The robot 1 and the operator 2 are communicably connected to each other. Specifically, the robot 1 is communicably connected to the controller 3. The operator 2 is communicably connected to the controller 3. That is, the operator 2 communicates with the robot 1 via the controller 3.

In this example, the robot 1 is an industrial robot. The robot 1 acts on the object W. The action of the robot 1 is specifically processing and more specifically grinding. The action is not limited to grinding, and for example, may be cutting or polishing.

The robot 1 has a sensor that detects an operation state of the robot 1. In this example, the robot 1 further has, as the sensor, a contact force sensor 13 that detects reactive force (hereinafter referred to as “contact force”) received from the object W.

The controller 3 receives a detection result of the contact force sensor 13 via the robot 1. The controller 3 executes operation control for at least one of the robot 1 or the operator 2 based on the detection result of the contact force sensor 13. In this example, according to operation of the operator 2 by the user and the detection result of the contact force sensor 13, the controller 3 controls operation of the robot 1, and controls operation of the operator 2 such that the reactive force acting on the robot 1 is applied to the user.

### [Robot]

The robot 1 may have an end effector 11 that acts on the object W and the robot arm 12 that operates the end effector 11. The robot 1 operates, i.e., moves, the end effector 11 by the robot arm 12, and accordingly, the end effector 11 acts on the object W. The robot 1 may further have a base 10 that supports the robot arm 12 and a robot controller 14 that controls the entirety of the robot 1.

For the robot 1, an orthogonal three-axis robot coordinate system is defined. For example, a Z-axis is set in the vertical direction, and an X-axis and a Y-axis orthogonal to each other are set in the horizontal direction.

The end effector 11 has a grinding device 11a, and as the action, grinds the object W. For example, the grinding device 11a may be a grinder, an orbital sander, a random orbital sander, a delta sander, or a belt sander. The grinder may be, for example, of such a type that a discoid grinding stone rotates or a conical or circular columnar grinding stone rotates. Here, the grinding device 11a is the grinder.

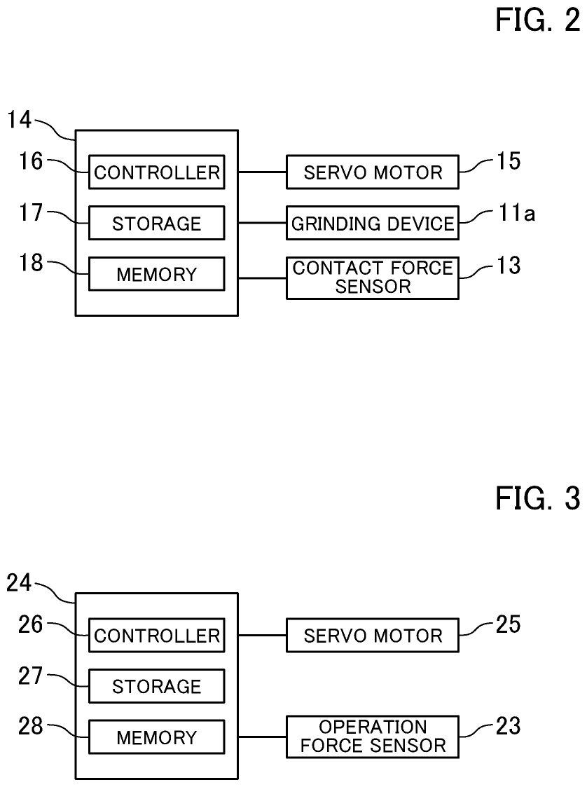

The robot arm 12 changes the position of the grinding device 11a. Further, the robot arm 12 may change the posture of the grinding device 11a. The robot arm 12 is a vertical articulated robot arm. The robot arm 12 has links 12a, joints 12b connecting the links 12a to each other, and a servo motor 15 (see FIG. 2) that rotationally drives the joints 12b.

Note that the robot arm 12 may be, for example, of a horizontal articulated type, a parallel link type, a Cartesian coordinate type, or a polar coordinate type.

In this example, the contact force sensor 13 is disposed between the robot arm 12 and the end effector 11 (specifically at a coupled portion between the robot arm 12 and the end effector 11). The contact force sensor 13 detects the contact force received from the object W by the end effector 11. The contact force sensor 13 detects force in the three axis directions orthogonal to each other and moment about these three axes.

Note that a force sensor is not limited to the contact force sensor 13. For example, the contact force sensor 13 may detect force only in uniaxial, biaxial, or triaxial directions. Alternatively, the force sensor may be, for example, a current sensor that detects the current of the servo motor 15 of the robot arm 12 or a torque sensor that detects the torque of the servo motor 15.

The imager 71 is attached to the robot arm 12. Specifically, the imager 71 is attached to the link 12a of the robot arm 12 closest to the tip end side thereof. The imager 71 captures an RGB image. The image captured by the imager 71 is input, as an image signal, from the robot controller 14 to the controller 3.

The three-dimensional scanner 72 is attached to the robot arm 12. Specifically, the three-dimensional scanner 72 is attached to the link 12a of the robot arm 12 closest to the tip end side thereof. The three-dimensional scanner 72 acquires point cloud data on the object W as the three-dimensional information. That is, the three-dimensional scanner 72 outputs, as a point cloud, the three-dimensional coordinates of many points on the surface of the object W. The point cloud data of the three-dimensional scanner 72 is input from the robot controller 14 to the controller 3.

The robot arm 12 moves the imager 71 to a predetermined imaging position when the image of the object W is acquired, and moves the three-dimensional scanner 72 to a position corresponding to the burr B detected by the first detector 83 when the point cloud data on the object W is acquired.

FIG. 2 is a diagram showing a schematic hardware configuration of the robot controller 14. The robot controller 14 controls the servo motor 15 of the robot arm 12 and the grinding device 11a. The robot controller 14 receives a detection signal of the contact force sensor 13. The robot controller 14 transmits information, commands, data, etc. to the controller 3, and receives information, commands, data, etc. from the controller 3. The robot controller 14 has a controller 16, a storage 17, and a memory 18.

The controller 16 controls the entirety of the robot controller 14. The controller 16 performs various types of arithmetic processing. For example, the controller 16 includes a processor such as a central processing unit (CPU). The controller 16 may include, for example, a micro controller unit (MCU), a micro processor unit (MPU), a field programmable gate array (FPGA), a programmable logic controller (PLC), and a system LSI.

The storage 17 stores programs to be executed by the controller 16 and various types of data. The storage 17 includes, for example, a non-volatile memory, a hard disc drive (HDD), and a solid state drive (SSD).

The memory 18 temporarily stores data etc. For example, the memory 18 includes a volatile memory.

### [Operator]

As shown in FIG. 1, the operator 2 has a handle 21 to be operated by the user and an operation force sensor 23 that detects operation force applied from the user to the handle 21. The operator 2 receives input for operating the robot 1 by manual operation, and outputs operation information which is the input information to the controller 3. Specifically, the user operates the operator 2 with gripping the handle 21. Force applied to the handle 21 at this time is detected by the operation force sensor 23. The operation force detected by the operation force sensor 23 is output as the operation information to the controller 3.

The operator 2 may further have a base 20, a support mechanism 22 that is disposed at the base 20 and supports the handle 21, and an operation controller 24 that controls the entirety of the operator 2. In response to control from the controller 3, the operator 2 applies reactive force of the operation force to the user. Specifically, the operation controller 24 controls the support mechanism 22 in response to a command from the controller 3, thereby causing the user to sense the reactive force.

For the operator 2, an orthogonal three-axis operation coordinate system is defined. The operation coordinate system corresponds to the robot coordinate system. That is, a Z-axis is set in the vertical direction, and an X-axis and a Y-axis orthogonal to each other are set in the horizontal direction.

The support mechanism 22 has links 22a, joints 22b connecting the links 22a to each other, and a servo motor 25 (see FIG. 3) that rotationally drives the joints 22b. The support mechanism 22 supports the handle 21 so that the handle 21 can be in an arbitrary posture at an arbitrary position in a three-dimensional space. According to the position and posture of the handle 21, the servo motor 25 rotates. The rotation amount, i.e., rotation angle, of the servo motor 25 is uniquely determined.

In this example, the operation force sensor 23 is disposed between the handle 21 and the support mechanism 22 (specifically at a coupled portion between the handle 21 and the support mechanism 22). The operation force sensor 23 detects force in the three axis directions orthogonal to each other and moment about these three axes.

Note that an operation force detector is not limited to the operation force sensor 23. For example, the operation force sensor 23 may detect force only in uniaxial, biaxial, or triaxial directions. Alternatively, the detector may be, for example, a current sensor that detects the current of the servo motor 25 of the support mechanism 22 or a torque sensor that detects the torque of the servo motor 25.

FIG. 3 is a diagram showing a schematic hardware configuration of the operation controller 24. The operation controller 24 controls the servo motor 25 to operate the support mechanism 22. The operation controller 24 receives a detection signal of the operation force sensor 23. The operation controller 24 transmits information, commands, data, etc. to the controller 3, and receives information, commands, data, etc. from the controller 3. The operation controller 24 has a controller 26, a storage 27, and a memory 28.

The controller 26 controls the entirety of the operation controller 24. The controller 26 performs various types of arithmetic processing. For example, the controller 26 includes a processor such as a central processing unit (CPU). The controller 26 may include, for example, a micro controller unit (MCU), a micro processor unit (MPU), a field programmable gate array (FPGA), a programmable logic controller (PLC), and a system LSI.

The storage 27 stores programs to be executed by the controller 26 and various types of data. The storage 27 includes, for example, a non-volatile memory, a hard disc drive (HDD), and a solid state drive (SSD).

The memory 28 temporarily stores data etc. For example, the memory 28 includes a volatile memory.

### [Controller]

The controller 3 controls the entirety of the processing system 100 and the detection system 200, and performs the operation control for the robot 1 and the operator 2. Specifically, the controller 3 performs, according to user's operation, manual control for the processing system 100 and automatic control for the processing system 100. In the manual control, the controller 3 performs master-slave control, specifically bilateral control, between the robot 1 and the operator 2. The controller 3 controls operation of the robot 1 according to operation of the operator 2 by user's operation, and controls operation of the operator 2 to apply the reactive force according to the detection result of the contact force sensor 13 to the user. That is, the end effector 11 processes the object W according to user's operation, and the reactive force in processing is applied to the user via the operator 2. In the automatic control, the controller 3 detects the burr B of the object W. Further, the controller 3 automatically grinds the burr B after detection of the burr B.

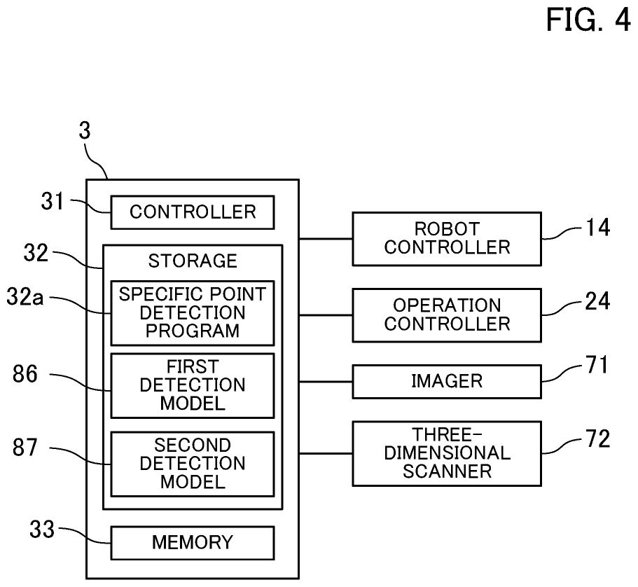

FIG. 4 is a diagram showing a schematic hardware configuration of the controller 3. The controller 3 transmits information, commands, data, etc. to the robot controller 14 and the operation controller 24, and receives information, commands, data, etc. from the robot controller 14 and the operation controller 24. The controller 3 has a controller 31, a storage 32, and a memory 33. Note that although not shown in the figure, the controller 3 may further have an input operator to be operated by the user to set the operation control for the robot 1 and the operator 2 and a display that displays setting contents.

The controller 31 controls the entirety of the controller 3. The controller 31 performs various types of arithmetic processing. For example, the controller 31 includes a processor such as a central processing unit (CPU). The controller 31 may include, for example, a micro controller unit (MCU), a micro processor unit (MPU), a field programmable gate array (FPGA), a programmable logic controller (PLC), and a system LSI.

The storage 32 stores programs to be executed by the controller 31 and various types of data. For example, the storage 32 stores programs for controlling the processing system 100 and the detection system 200. The storage 32 includes, for example, a non-volatile memory, a hard disc drive (HDD), and a solid state drive (SSD). For example, the programs stored in the storage 32 include a specific point detection program 32a causing a computer to execute predetermined steps to detect the burr B of the object W.

The memory 33 temporarily stores data etc. For example, the memory 33 includes a volatile memory.

### <Control for Processing System>

When the manual processing is executed in the processing system 100 configured in this manner, the controller 3 executes the manual control of controlling operation of the robot 1 according to operation of the operator 2 by the user's operation and controlling operation of the operator 2 to apply the reactive force according to the detection result of the contact force sensor 13 to the user. When the automatic processing is executed, the controller 3 executes the automatic control of detecting the burr B based on the image of the object W from the imager 71 and the three-dimensional information on the object W from the three-dimensional scanner 72 and processing the detected burr B by the robot 1.

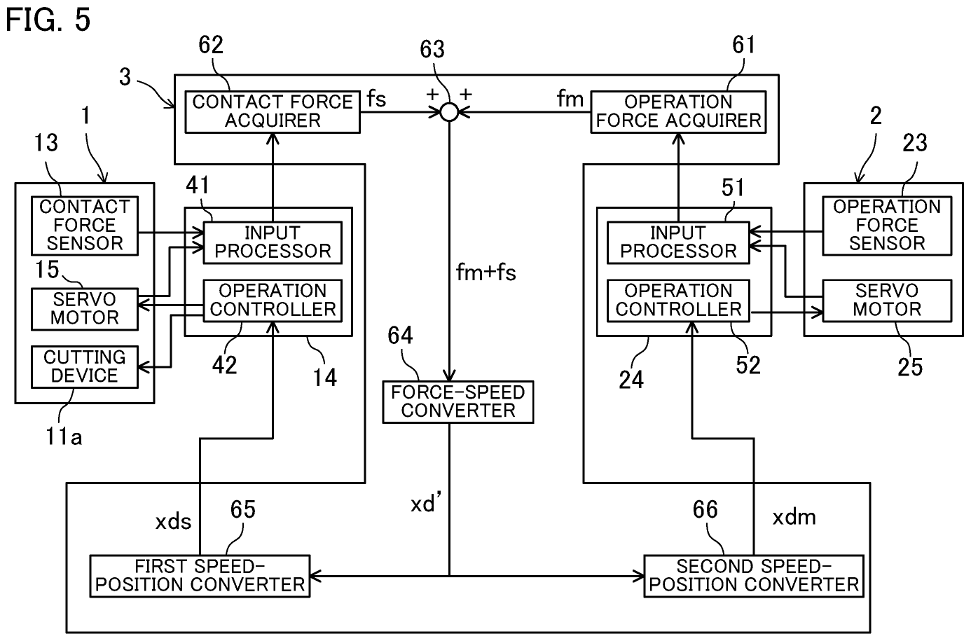

First, the manual control for the processing system 100 will be described. FIG. 5 is a block diagram showing the configuration of a control system for the manual control for the processing system 100.

The controller 16 of the robot controller 14 reads and loads the programs from the storage 17 into the memory 18, thereby implementing various functions. Specifically, the controller 16 functions as an input processor 41 and an operation controller 42.

The input processor 41 outputs, to the controller 3, information, data, commands, etc. received from the contact force sensor 13 and the servo motor 15. Specifically, the input processor 41 receives a six-axis force detection signal (hereinafter referred to as a “sensor signal”) from the contact force sensor 13, and outputs the sensor signal to the controller 3. Moreover, the input processor 41 receives, from the servo motor 15, detection signals of a rotation sensor (e.g., encoder) and a current sensor. The input processor 41 outputs, to the operation controller 42, these detection signals for feedback control for the robot arm 12 by the operation controller 42. Further, the input processor 41 outputs these detection signals as position information on the robot arm 12 to the controller 3.

The operation controller 42 receives a command position xds from the controller 3, and according to the command position xds, generates a control command for operating the robot arm 12. The operation controller 42 outputs the control command to the servo motor 15 to operate the robot arm 12 and move the grinding device 11a to a position corresponding to the command position. At this time, the operation controller 42 performs feedback control of operation of the robot arm 12 based on the detection signals of the rotation sensor and/or the current sensor of the servo motor 15 from the input processor 41. Moreover, the operation controller 42 outputs the control command to the grinding device 11a to operate the grinding device 11a. Accordingly, the grinding device 11a grinds the object W.

The controller 26 of the operation controller 24 reads and loads the programs from the storage 27 into the memory 28, thereby implementing various functions. Specifically, the controller 26 functions as an input processor 51 and an operation controller 52.

The input processor 51 outputs, to the controller 3, information, data, commands, etc. received from the operation force sensor 23. Specifically, the input processor 51 receives a six-axis force detection signal from the operation force sensor 23, and outputs the detection signal to the controller 3. Moreover, the input processor 51 receives, from the servo motor 25, detection signals of a rotation sensor (e.g., encoder) and a current sensor. The input processor 51 outputs, to the operation controller 52, these detection signals for feedback control for the support mechanism 22 by the operation controller 52.

The operation controller 52 receives a command position xdm from the controller 3, and according to the command position xdm, generates a control command for operating the support mechanism 22. The operation controller 52 outputs the control command to the servo motor 25 to operate the support mechanism 22 and move the handle 21 to a position corresponding to the command position. At this time, the operation controller 52 performs feedback control of operation of the support mechanism 22 based on the detection signals of the rotation sensor and/or the current sensor of the servo motor 25 from the input processor 51. Accordingly, the reactive force of the operation force on the handle 21 from the user is applied. As a result, the user can operate the handle 21 while artificially sensing the reactive force from the object W via the handle 21.

The controller 31 of the controller 3 reads and loads the programs from the storage 32 into the memory 33, thereby implementing various functions. Specifically, the controller 31 functions as an operation force acquirer 61, a contact force acquirer 62, an adder 63, a force-speed converter 64, a first speed-position converter 65, and a second speed-position converter 66.

The operation force acquirer 61 receives the detection signal of the operation force sensor 23 via the input processor 51, and based on the detection signal, acquires an operation force fm. The operation force acquirer 61 inputs the operation force fm to the adder 63.

The contact force acquirer 62 receives the sensor signal of the contact force sensor 13 via the input processor 41, and based on the sensor signal, acquires a contact force fs. The contact force acquirer 62 inputs the contact force fs to the adder 63.

The adder 63 calculates the sum of the operation force fm input from the operation force acquirer 61 and the contact force fs input from the contact force acquirer 62. Here, the operation force fm and the contact force fs are in opposite directions, and for this reason, the positive and negative signs are different between the operation force fm and the contact force fs. That is, by addition of the operation force fm and the contact force fs, the absolute value of a resultant force fm+fs which is the sum of the operation force fm and the contact force fs is smaller than the absolute value of the operation force fm. The adder 63 outputs the resultant force fm+fs.

The force-speed converter 64 converts the input resultant force fm+fs into a command speed xd′. The force-speed converter 64 calculates the command speed xd′ using a motion model based on a motion equation including an inertial coefficient, a viscosity coefficient (damper coefficient), and a stiffness coefficient (spring coefficient). Specifically, the force-speed converter 64 calculates the command speed xd′ based on the following motion equation.

[Equation 1]

md·xd″+cd·xd′+kd·xd=fm+fs (1)

where xd is a command position, md is an inertial coefficient, cd is a viscosity coefficient, kd is a stiffness coefficient, fm is an operation force, and fs is a contact force. Note that “′” indicates one-time differentiation and “″” indicates two-time differentiation.

Equation (1) is a linear differential equation, and when Equation (1) is solved for xd′, Equation (2) is given.

[Equation 2]

xd′=A (2)

where A is a term represented by fm, fs, md, cd, kd, etc.

Equation (2) is stored in the storage 32. The force-speed converter 64 reads Equation (2) from the storage 32, and obtains the command speed xd′. The force-speed converter 64 outputs the obtained command speed xd′ to the first speed-position converter 65 and the second speed-position converter 66.

The first speed-position converter 65 converts the command speed xd′ subjected to coordinate conversion into a command position xds for the robot 1 with reference to the robot coordinate system. For example, in a case where the ratio of the movement amount of the robot 1 to the movement amount of the operator 2 is set, the first speed-position converter 65 obtains the command position xds by multiplying a command position xd obtained from the command speed xd′ according to the movement ratio. The first speed-position converter 65 outputs the obtained command position xds to the robot controller 14, specifically the operation controller 42. As described above, the operation controller 42 operates the robot arm 12 based on the command position xds.

The second speed-position converter 66 converts the command speed xd′ into a command position xdm for the operator 2 with reference to the operation coordinate system. The second speed-position converter 66 outputs the obtained command position xdm to the operation controller 24, specifically the operation controller 52. As described above, the operation controller 52 operates the support mechanism 22 based on the command position xdm.

Next, the automatic control for the processing system 100 will be described. FIG. 6 is a block diagram showing the configuration of a control system for the automatic control for the processing system 100.

The controller 31 of the controller 3 reads and loads the programs (e.g., specific point detection program 32a) from the storage 32 into the memory 33, thereby implementing various functions. Specifically, the controller 31 functions as an operation commander 81, an image controller 82, the first detector 83, a three-dimensional information controller 84, and the second detector 85.

Using a first detection model 86 learned by machine learning, the first detector 83 detects the burr B included in the object W by taking the image acquired by the imager 71 as input (hereinafter, such detection will also be referred to as “first detection”). Using a second detection model 87 learned by machine learning, the second detector 85 re-detects the burr B by taking the point cloud data acquired by the three-dimensional scanner 72 as input (hereinafter, such detection will also be referred to as “second detection”). The first detection model 86 and the second detection model 87 are saved in the storage 32.

The operation commander 81 creates the command position of the robot arm 12, and obtains the rotation angle of each joint 12b of the robot arm 12 according to the created command position. Further, the operation commander 81 creates a command value according to the obtained rotation angle of each joint 12b, and outputs the created command value to the robot controller 14.

The robot controller 14 drives the servo motor 15 based on the command value from the operation commander 81. At this time, the robot controller 14 performs feedback control of current supply to the servo motor 15 based on the detection result of the encoder.

The image controller 82 controls the imager 71 to image the object W.

The first detector 83 detects the burr B of the object W based on the image acquired by the imager 71. The first detector 83 detects the burr B using the first detection model 86 learned by machine learning. The first detection model 86 outputs the position of the burr B of the object W by taking the image of the object W as input.

The three-dimensional information controller 84 controls the three-dimensional scanner 72 to acquire the point cloud data on the object W.

The second detector 85 detects the burr B of the object W based on the point cloud data acquired by the three-dimensional scanner 72. The second detector 85 detects the burr B using the second detection model 87 learned by machine learning. The second detection model 87 outputs the position of the burr B of the object W by taking the point cloud data on the object W as input.

The first detection model 86 and the second detection model 87 will be further described.

The first detection model 86 is created by machine learning such as deep learning or a neural network. For example, images of the object W before and after grinding of the burr B are acquired, and from the acquired images, training data subjected to annotation of a class and a region (i.e., position) according to attributes indicating whether to be the burr B or portions other than the burr B is created. Using a deep learning algorithm such as a neural network, the first detection model 86 is created by taking the created training data as input. The first detection model 86 outputs the presence or absence of the burr B and the position of the burr B by taking the image of the object W as input.

More specifically, the first detection model 86 may be a machine learning model having an extraction block for extracting the feature amount of the burr from the image, a position prediction block for performing regressive prediction for the position coordinates of the burr from the feature amount extracted in the extraction block, and a prediction block for predicting the class of the burr from the feature amount extracted in the extraction block. For extraction of the feature amount in the extraction block, a convolutional neural network is used. Note that a convolutional neural network including all the blocks may be used. Each block is not necessarily independent, and one block may have the functions of blocks.

The training data for the first detection model 86 is an image including a relatively-large area of the object W, such as an image including the entirety or a large portion of the object W. According to the type of object W, various images of the object W having the burr B are employed as the training data. Moreover, the training data for the first detection model 86 is preferably images of the object W before and after actual processing by the processing system 100 under the manual control. The object W is actually manually processed using the processing system 100, and at this time, the images of the object W before and after grinding are acquired. With these images, the training data can be easily obtained. Further, an image reflecting on-site environment where the robot 1 is actually installed can be acquired, and therefore, the first detection model 86 with a high accuracy of detection of the burr B is created.

The second detection model 87 is created by machine learning with a higher explainability or readability than that of the first detection model 86. For example, the second detection model 87 is created using a machine learning algorithm of a decision tree system. For example, training data subjected to annotation of a class and a region (i.e., position) according to attributes indicating whether to be the burr B or portions other than the burr B is created from point cloud data acquired from a sample of the burr B. Using the machine learning algorithm of the decision tree system, the second detection model 87 is created by taking the created training data as input. The second detection model 87 outputs the presence or absence of the burr B of the object W and the position of the burr B by taking the point cloud data on the object W as input.

More specifically, the second detection model 87 may be a machine learning model having a calculation block for calculating a local feature amount for each point of the point cloud data or each voxel region generated from the point cloud data, a prediction block for predicting the class of the burr from the feature amount calculated in the calculation block, and a position calculation block for calculating the position coordinates of the burr from the feature amount calculated in the calculation block, the class predicted in the prediction block, and geometric processing on the point cloud data. The machine learning algorithm of the decision tree system is used for the prediction block. Each block is not necessarily independent, and one block may have the functions of blocks.

The area of the object W indicated by the point cloud data is only required to be a local portion including the burr B, and may be smaller than the area of the object W indicated by the image input to the first detection model 86. The second detection model 87 is a model created by machine learning allowing sequential learning. That is, the learned second detection model 87 is updated using new training data by additional machine learning.

The training data for the second detection model 87 is an image including a relatively-small area of the object W, such as a local image including the burr B. The training data is not necessarily point cloud data on the entire sample, and is only required to be point cloud data on a local portion including at least the burr B. Thus, the sample may be the same type of component as the object W, or may be a different type of component from the object W.

The area of the object W input as the point cloud data to the second detection model 87 is narrower than the area of the object W input as the image to the first detection model 86. In other words, the object W indicated by the point cloud data input to the second detection model 87 is more local than the object W indicated by the image input to the first detection model 86.

In this manner, the first detection model 86 globally and preliminarily detects, based on the image of the object W, the burr B from the entirety of the object W. Thereafter, the second detection model 87 locally checks the burr B detected by the first detector 83 based on the point cloud data on the object W, and re-detects the burr B with a higher accuracy than that of the first detection model 86.

### [Operation of Processing System]

Next, operation of the processing system 100 configured in this manner will be described.

### <Manual Control>

In the manual control, the user operates the operator 2, thereby causing the robot 1 to execute an actual work on the object W. For example, the user operates the operator 2, thereby causing the robot 1 to grind the object W. As user's operation via the operator 2, the operation force applied from the user to the handle 21 is detected by the operation force sensor 23. The robot arm 12 is controlled according to the operation force.

Specifically, when the user operates the operator 2, the operation force applied from the user via the handle 21 is detected by the operation force sensor 23. At this time, the contact force sensor 13 of the robot 1 detects the contact force.

The operation force detected by the operation force sensor 23 is input, as the detection signal, to the controller 3 by the input processor 51. In the controller 3, the operation force acquirer 61 inputs the operation force fm based on the detection signal to the adder 63.

At this time, the contact force detected by the contact force sensor 13 is input, as the sensor signal, to the input processor 41. The sensor signal input to the input processor 41 is input to the contact force acquirer 62. The contact force acquirer 62 inputs the contact force fs based on the sensor signal to the adder 63.

The adder 63 inputs the resultant force fm+fs to the force-speed converter 64. The force-speed converter 64 obtains the command speed xd′ using the resultant force fm+fs based on Equation (2).

For the robot 1, the first speed-position converter 65 obtains the command position xds from the command speed xd′. The operation controller 42 of the robot controller 14 operates the robot arm 12 according to the command position xds, and controls the position of the grinding device 11a. Accordingly, pressing force corresponding to the operation force fm is applied to the object W while the grinding device 11a is grinding the object W.

On the other hand, for the operator 2, the second speed-position converter 66 obtains the command position xdm from the command speed xd′. The operation controller 52 of the operation controller 24 operates the support mechanism 22 according to the command position xdm, and controls the position of the handle 21. Accordingly, the user senses the reactive force corresponding to the contact force fs.

By such operation of the operator 2 by the user, processing of the object W by the robot 1 is executed.

Note that the images of the object W are preferably acquired as described above before and after processing of the object W by such user's manual operation. Using the acquired images as the training data, the first detection model 86 can be created.

### <Automatic Control>

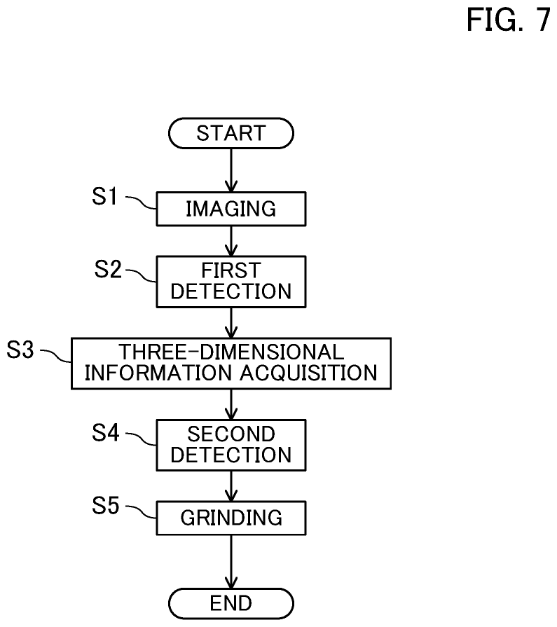

Subsequently, operation in the automatic control for the processing system 100 will be described. FIG. 7 is a flowchart of the automatic control for the processing system 100.

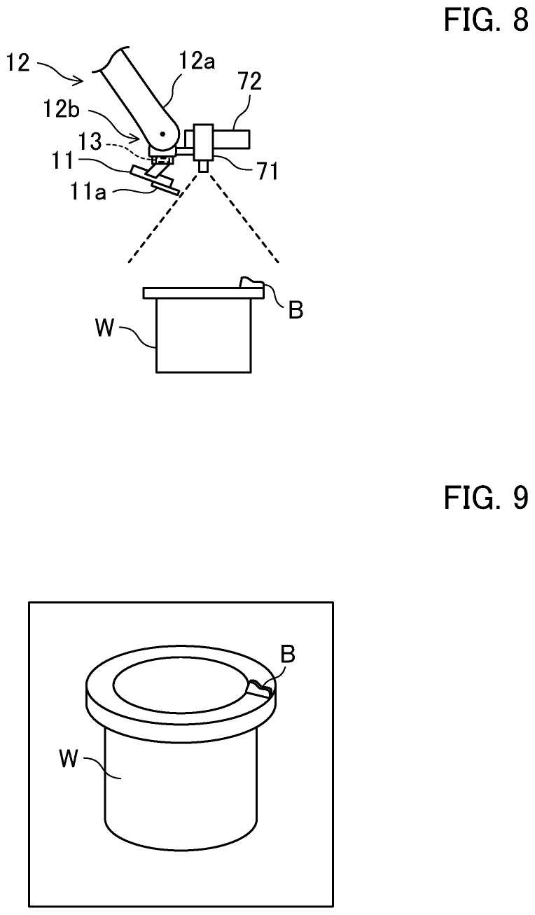

First, in Step S1, the controller 3 executes imaging of the object W. FIG. 8 is a schematic view showing the state of the robot arm 12 in imaging of the object W. FIG. 9 is a schematic view showing one example of the image acquired by the imager 71.

Specifically, as shown in FIG. 8, the operation commander 81 moves the robot arm 12 such that the imager 71 is at a predetermined imaging position. Thereafter, the image controller 82 causes the imager 71 to image the object W. For example, the imager 71 images the object W such that the image of the entirety of the object W is acquired, as shown in FIG. 9.

Note that the object W is not necessarily imaged once, but may be imaged multiple times. That is, the imager 71 moves to imaging positions, and images the object W at each imaging position.

The controller 3 may execute acquisition of the point cloud data on the object W to detect the position of the object W in the robot coordinate system. At this time, the three-dimensional information controller 84 causes the three-dimensional scanner 72 to acquire the point cloud data on the relatively-large area (preferably, the entire area of the object W) of the object W. For example, at the position of the robot arm 12 when the above-described imaging of the object W is executed, the three-dimensional scanner 72 acquires the point cloud data on the object W. Note that in a case where the position of the robot arm 12 (i.e., the position of the three-dimensional scanner) in imaging of the object W is not suitable for acquisition of the point cloud data on the large area of the object W, the operation commander 81 may move the robot arm 12 to a proper position, and then, the three-dimensional scanner 72 may acquire the point cloud data on a proper area of the object W.

Note that in a case where the position of the object W in the robot coordinate system is known or a case where the position of the object W is detected using, e.g., the acquired image of the object W in Step S1, the above-described acquisition of the point cloud data on the object W can be omitted.

In Step S2, the controller 3 executes the first detection of the burr B from the image acquired by the imager 71. Specifically, the first detector 83 inputs the acquired image to the first detection model 86. The first detection model 86 outputs the position of the burr B. Note that in a case where the object W has no burr B, the first detection model 86 outputs an indication of no burr B being included in the object W. The first detection is executed the number of times corresponding to the number of acquired images.

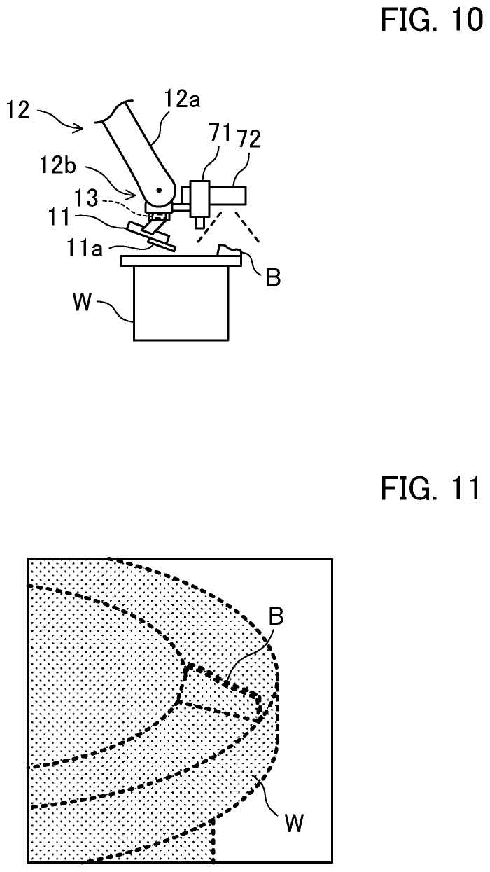

In Step S3, the controller 3 executes acquisition of the point cloud data on the object W. FIG. 10 is a schematic view showing the state of the robot arm 12 in acquisition of the point cloud data on the object W. FIG. 11 is a schematic view showing one example of the point cloud data acquired by the three-dimensional scanner 72.

Specifically, the operation commander 81 moves the robot arm 12 such that the three-dimensional scanner 72 is at a position at which the point cloud data on a portion of the object W including the burr B detected by the first detection can be acquired. The operation commander 81 moves the robot arm 12 based on the position of the burr B detected by the first detection. Thereafter, the three-dimensional information controller 84 causes the three-dimensional scanner 72 to acquire the point cloud data on the object W. For example, the three-dimensional scanner 72 does not acquire the point cloud data on the entirety of the object W, but acquires the point cloud data on the local portion of the object W including at least the burr B.

Note that the number of times of acquisition of the point cloud data on the object W corresponds to the number of burrs B detected by the first detection. That is, in a case where burrs B are detected by the first detection, pieces of point cloud data are acquired. Note that in a case where burrs B are included in a piece of point cloud data, acquisition of the point cloud data is executed once for these burrs B.

In Step S4, the controller 3 executes the second detection of the burr B from the point cloud data acquired by the three-dimensional scanner 72. Specifically, the second detector 85 inputs the point cloud data to the second detection model 87. The second detection model 87 outputs the position of the burr B. Note that in a case where the object W includes no burr B, the second detection model 87 outputs an indication of no burr B being included in the object W. Detection of the burr B by the second detection model 87 is executed the same number of times as the number of times of acquisition of the point cloud data.

Input to the second detection model 87 is the point cloud data on the burr B preliminarily detected by the first detection model 86. That is, detection of the burr B by the second detection model 87 is re-detection, i.e., re-evaluation, of the burr B detected by the first detection model 86. The first detection model 86 detects the burr B from the two-dimensional image whereas the second detection model 87 detects the burr B from the point cloud data which is the three-dimensional information. Thus, the second detection model 87 can detect the burr B with a higher accuracy than that of the first detection model 86. Further, the point cloud data input to the second detection model 87 is the point cloud data on the local portion of the object W. On this point, the second detection model 87 can also detect the burr B with a higher accuracy.

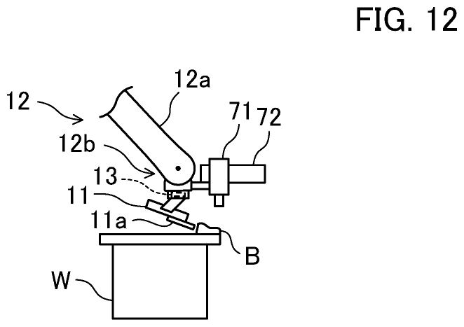

In Step S5, the controller 3 executes grinding of the burr B. FIG. 12 is a schematic view showing the state of the robot arm 12 when the burr B is ground. Specifically, the operation commander 81 outputs the control command to the grinding device 11a to operate the grinding device 11a. Then, the operation commander 81 moves the robot arm 12 such that the grinding device 11a grinds the burr B detected by the second detection. The operation commander 81 moves the robot arm 12 based on the position of the burr B detected by the second detection. Accordingly, the grinding device 11a grinds the object W. Grinding is executed on all the burrs B detected by the second detection.

According to the automatic control for the processing system 100, the processing system 100 detects the burr B of the object W, and grinds the detected burr B by the grinding device 11a. First, the burr B included in the object W is preliminarily detected using the first detection model 86 by taking the image of the object W as input. Thereafter, the three-dimensional scanner 72 acquires the point cloud data on the object W, which includes the burr B detected by the first detection model 86. By taking the point cloud data on the object W as input, the second detection model 87 finally detects the burr B included in the object W.

Since the burr B is finally detected based on the point cloud data, the accuracy of detection of the burr B is improved. The point cloud data on the entirety of the object W is not necessarily acquired, but the point cloud data including the burr B preliminarily detected from the image of the object W is only required to be acquired. Thus, the point cloud data, which indicates the enlarged burr B, on the local portion of the object W can be acquired, and therefore, fine point cloud data on the burr B can be acquired. Thus, the accuracy of detection of the burr B is also improved.

In a case where fine point cloud data on the entirety of the object W is acquired, the object W needs to be divided into pieces and acquire the point cloud data multiple times. However, the burr B is preliminarily detected using the first detection model 86 so that the area of the object W on which the point cloud data is acquired can be limited. Thus, the number of times of acquisition of the point cloud data can be reduced. That is, the number of steps of acquiring the point cloud data can be reduced, and as a result, the number of steps of analyzing the point cloud data (i.e., the number of steps of detecting the burr B using the second detection model 87) can be reduced.

According to specific point detection in the processing system 100, even if there is no three-dimensional data such as design data, the burr B can be detected with favorable accuracy and the processing from acquisition of the point cloud data on the object W to detection of the burr B can be simplified.

Particularly, the resolution of the three-dimensional information such as the point cloud data is finite, and if the three-dimensional scanner 72 acquires the point cloud data on the relatively-large area of the object W, there is a probability that data corresponding to the burr B is missing. On the other hand, as described above, the burr B is preliminarily detected using the first detection model 86 so that the point cloud data on the enlarged burr B can be acquired with the three-dimensional scanner 72 positioned close to the burr B when acquiring the point cloud data on the object W. Accordingly, missing of the data corresponding to the burr B in the point cloud data can be prevented.

The second detection model 87 detects the burr B by taking the point cloud data on the local portion of the object W including the burr B as input, and therefore, the training data for the second detection model 87 is the point cloud data including the burr B and does not depend on the type of object W. That is, the point cloud data on the burr B of the different type of object W may be taken as the training data. Thus, the learned second detection model 87 can be applied to detection of the burr B of various types of objects W regardless of the type of object W.

As described above, the detection system 200 includes the imager 71 that acquires the image of the object W, the first detector 83 that detects, using the first detection model 86 learned by machine learning, the burr B (specific point) included in the object W by taking the image acquired by the imager 71 as input, the three-dimensional scanner 72 (three-dimensional information acquirer) that acquires the three-dimensional information on the object W including the burr B detected by the first detector 83, and the second detector 85 that re-detects, using the second detection model 87 learned by machine learning, the burr B by taking the three-dimensional information acquired by the three-dimensional scanner 72 as input.

In other words, the specific point detection method by the specific point detection system includes acquiring the image of the object W, detecting, using the first detection model 86 learned by machine learning, the burr B (specific point) included in the object W by taking the image as input, acquiring the three-dimensional information on the object W including the burr B detected by the first detection model 86, and re-detecting, using the second detection model 87 learned by machine learning, the burr B by taking the three-dimensional information as input.

The specific point detection program causes, for detecting the burr B of the object W, the computer to execute acquiring the image of the object W, detecting, using the first detection model 86 learned by machine learning, the burr B (specific point) included in the object W by taking the image as input, acquiring the three-dimensional information on the object W including the burr B detected by the first detection model 86, and re-detecting, using the second detection model 87 learned by machine learning, the burr B by taking the three-dimensional information as input.

According to these configurations, the burr B included in the object W is detected using the first detection model 86 by taking the image of the object W acquired by the imager 71 as input. The three-dimensional scanner 72 acquires the three-dimensional information on the object W including the burr B detected using the first detection model 86. The burr B included in the object W is detected using the second detection model 87 by taking the acquired three-dimensional information as input. That is, detection of the burr B based on the image of the object W is preliminary detection. The three-dimensional scanner 72 acquires the three-dimensional information on the burr B whose position is specified by preliminary detection of the burr B. Thus, the three-dimensional information on the local portion of the burr B, i.e., the three-dimensional information on the enlarged burr B, can be acquired. The burr B is detected using the second detection model 87 by taking such three-dimensional information as input so that the burr B can be detected with favorable accuracy. That is, detection of the burr B based on the three-dimensional information on the object W is final or conclusive detection. Detection of the burr B by the first detector 83 and detection of the burr B by the second detector 85 are sequentially performed so that the area of the object W on which the three-dimensional information is acquired can be limited. Thus, the number of steps of acquiring the three-dimensional information can be reduced, and fine three-dimensional information on the burr B can be acquired. As a result, the processing when the burr B is detected from the three-dimensional information on the object W can be facilitated, and the accuracy of detection of the burr B can be improved.

The area of the object W input to the second detection model 87 as the three-dimensional information is narrower than the area of the object W input to the first detection model 86 as the image.

According to this configuration, the burr B is detected using the first detection model 86 by taking the image of the relatively-large area of the object W as input whereas the burr B is detected using the second detection model 87 by taking the three-dimensional information on the relatively-narrow area of the object W as input. Since detection of the burr B by the first detection model 86 is preliminary detection, the burr B can be detected from the large area of the object W by inputting the image of the relatively-large area of the object W. Since detection of the burr B by the second detection model 87 is re-detection of the burr B detected by the first detection model 86, fine three-dimensional information can be used by inputting the three-dimensional information on the relatively-narrow area of the object W and the accuracy of detection of the burr B can be enhanced.

Specifically, the three-dimensional information is the point cloud data.

According to this configuration, the position of the burr B on the object W is preliminarily specified by detection of the burr B by the first detection model 86, and thereafter, the point cloud data on the burr B is acquired by the three-dimensional scanner 72. Thus, the point cloud data on the enlarged burr B can be acquired, and missing of the point cloud data corresponding to the burr B can be prevented.

The machine learning for the second detection model 87 has a higher explainability than that of the machine learning for the first detection model 86.

According to this configuration, since the machine learning for the second detection model 87 has a higher explainability, a cause for erroneous detection of the burr B is easily examined if such erroneous detection occurs. Moreover, the machine learning with a higher explainability also allows additional learning, and therefore, the additional learning can be performed using erroneously-detected three-dimensional information as the training data and the second detection model 87 can be easily updated.

The detection system 200 further includes the robot arm 12, the imager 71 and the three-dimensional scanner 72 are located at the robot arm 12, and the robot arm 12 moves the imager 71 to the predetermined imaging position when the image of the object W is acquired and moves the three-dimensional scanner 72 to the position corresponding to the burr B detected by the first detector 83 when the three-dimensional information on the object W is acquired.

According to this configuration, movement of the imager 71 and the three-dimensional scanner 72 is performed by the robot arm 12. Thus, the imager 71 can be flexibly moved to the imaging position suitable for acquisition of the image of the object W, and the three-dimensional scanner 72 can be flexibly moved to the position suitable for acquisition of the three-dimensional information on the object W. For example, the robot arm 12 can move the imager 71 to imaging positions such that no portion which cannot be imaged due to a blind angle remains, and the images of the object W can be acquired multiple times. Moreover, the robot arm 12 can move the three-dimensional scanner 72 to the optimal position for acquisition of the three-dimensional information on the burr B detected by the first detection model 86.

### Other Embodiments

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the detection system 200 is incorporated into the processing system 100, but the present disclosure is not limited thereto. The robot 1 is not limited to those capable of executing the bilateral control. For example, the operator 2 may be omitted.

The detection system 200 is only required to detect the burr B, and it is not essential for the detection system 200 to process the burr B.

The specific point of the object is not limited to the burr B. An arbitrary portion is the specific point as long as the specific point can be detected, using the learned model, by taking each of the image and the three-dimensional information as input. For example, the specific point may be a coating or welding object point (i.e., point where coating or welding is performed) of the object. In a case where the coating or welding object point is distinguishable from other portions of the object, the first detection model 86 and the second detection model 87 are created such that the coating or welding object point is detectable. With this configuration, the coating or welding object point can be detected by taking each of the image and the three-dimensional information as input. In this case, processing by the processing system 100 is not grinding, but coating or welding.

The imager 71 is not necessarily disposed at the robot arm 12. For example, the imager 71 may be fixed to a location apart from the robot 1. For example, the imager 71 may be located above the robot 1 and the object W.

The device that moves the three-dimensional scanner 72 is not limited to the robot arm 12. The three-dimensional scanner 72 is located at an arbitrary device as long as the three-dimensional scanner 72 is movable to a position suitable for acquisition of the three-dimensional information on the specific point detected by the first detection.

The three-dimensional information on the object is not limited to the point cloud data. The three-dimensional information is only required to be information indicating the three-dimensional shape of the object. For example, the three-dimensional information may be a depth image.

The training data for the first detection model 86 is not limited to the images of the object W before and after actual processing by the processing system 100 under the manual control. The training data for the first detection model 86 is not limited to the image reflecting the on-site environment where the robot 1 is actually installed, and an arbitrary image may be employed.

The first detection model 86 may be a model learned by machine learning using deep learning. The deep learning may be, for example, a neural network, more specifically a convolutional neural network.

The second detection model 87 is not limited to the model learned by machine learning using the decision tree system. The second detection model 87 may be an arbitrary model as long as the specific point can be detected by taking the three-dimensional information such as the point cloud data as input. For example, the second detection model 87 may be a regression model using, e.g., logistic regression or a support vector machine or a tree structure model using, e.g., a regression tree, a gradient boosting tree, or a random forest. Alternatively, the second detection model 87 may be a rule-based model. These exemplary models as the second detection model 87 have a relatively-high explainability.

1. A specific point detection system comprising:
an imager that acquires an image of an object;
a first detector that detects, using a first detection model learned by machine learning, a specific point included in the object by taking the image acquired by the imager as input;
a three-dimensional information acquirer that acquires three-dimensional information on the object including the specific point detected by the first detector; and
a second detector that re-detects, using a second detection model learned by machine learning, the specific point by taking the three-dimensional information acquired by the three-dimensional information acquirer as input.

2. The specific point detection system of claim 1, wherein
an area of the object input to the second detection model as the three-dimensional information is narrower than an area of the object input to the first detection model as the image.

3. The specific point detection system of claim 1, wherein
the three-dimensional information is point cloud data.

4. The specific point detection system of claim 1, wherein
the machine learning for the second detection model has a higher explainability than that of the machine learning for the first detection model.

5. The specific point detection system of claim 1, further comprising:
a robot arm, wherein
the imager and the three-dimensional information acquirer are located at the robot arm, and
the robot arm
moves the imager to a predetermined imaging position when the image of the object is acquired, and
moves the three-dimensional information acquirer to a position corresponding to the specific point detected by the first detector when the three-dimensional information on the object is acquired.

6. A specific point detection method comprising:
acquiring an image of an object;
detecting, using a first detection model learned by machine learning, a specific point included in the object by taking the image as input;
acquiring three-dimensional information on the object including the specific point detected by the first detection model; and
re-detecting, using a second detection model learned by machine learning, the specific point by taking the three-dimensional information as input.

7. An article of manufacture comprising a computer-readable medium storing a specific point detection program for detecting a specific point of an object, the program, when executed, causing a computer to execute operations comprising:
acquiring an image of the object;
detecting, using a first detection model learned by machine learning, the specific point included in the object by taking the image as input;
acquiring three-dimensional information on the object including the specific point detected by the first detection model; and
re-detecting, using a second detection model learned by machine learning, the specific point by taking the three-dimensional information as input.
